(19) United States
(12) Patent Application Publication
(10) Pub. No.: US 2011/0191088 A1
(43) Pub. Date: Aug. 4, 2011

(54) OBJECT-ORIENTED NETWORK-ON-CHIP MODELING

(76) Inventors: Yar-Sun HSU, Hsinchu City (TW); Chi-Fu Chang, Taipei City (TW)

(21) Appl. No.: 12/697,649

(22) Filed: Feb. 1, 2010

(51) Int. Cl. G06F 17/50

(52) U.S. Cl. 703/13

(57) ABSTRACT

Network-on-Chip (NoC) is an oncoming solution to the communication bottleneck of System-on-Chip (SoC). For a good design, it runs a simulation verification before the design is realized. The key factors to the accuracy and simulation speed of a simulator depend on how the simulator abstracts the NoC design. The present invention provides an object-oriented NoC modeling, which divides the NoC design space into many design blocks and models them into many abstraction levels. The present invention defines these models carefully to obtain good hardware accuracy. The present invention also provides an object implementation library of different abstraction levels. Thereby, the present invention can reduce the coding time via selecting required components from the object implementation library, inheriting them with some modifications or using them directly. The present invention extends the design exploration space of NoC, preserves good hardware characteristics, and significantly reduces coding effort of a new NoC design.

### FIELD OF THE INVENTION

The present invention is related to a network-on-chip, particularly to a network-on-chip modeling for the SoC simulation.

### BACKGROUND OF THE INVENTION

The complexity of SoC (System-on-Chip) is increasing with the advance of VLSI. Because of the increasing number of multi-core processors, IP units, controllers, etc., of one SoC, the performance bottleneck has transferred from the computation circuits to the communication circuits, and the communication bottleneck is more serious. Thus, the on-chip communication architecture has become a key point in the design of SoC.

The SoC design is originally computation-oriented but now turns to be communication-oriented. The Network-on-Chip (NoC) is a popular solution to the communication architecture. NoC can solve many problems frequently occurring in the architecture of buses, such as the problems of low scalability and low throughout. Nevertheless, NoC requires more hardware resources, such as buffers and switches, and involves the design of complicated and power-consuming circuits, such as routing units. Therefore, it is very important, before NoC is physically constructed, to undertake design exploration and system simulation to examine whether a better cost-efficiency ratio can be achieved.

There are two approaches used in NoC modeling. One of the approaches models NoC according to a commonly-used topology (such as a mesh-like network or a ring-like network) and adds some parameterizable and behavior-modifiable routing models to the topology to simulate the intended design. However, such an approach is unlikely to describe other topologies, such as a bus-like NoC and a direct-linked NoC. Therefore, the first approach is less flexible and restricts the exploration space of NoC design. It is unlikely to do a comparison between router-based NoC and bus-like NoC either.

Another approach adopts an abstract modeling process, such as the UML (Universal Modeling Language) module. Although the second approach can describe a wider range of NoC designs simply, some hardware characteristics are sacrificed.

The present invention proposes an object-oriented NoC modeling process, which is exempt from the disadvantages of the abovementioned two approaches and has a larger design exploration space and a fine hardware behavior granularity. The present invention divides the system into many components according to the hardware graphs and models the components into multi-abstraction-level objects. The object-oriented NoC modeling of the present invention provides different abstraction levels of object implementation libraries. The components taken from the implementation library are directly used, or are inherited and then modified, whereby the coding time for a new NoC design is reduced in the consideration of NoC hardware characteristics. Below, the technical contents of the present invention are to be described in detail.

### SUMMARY OF THE INVENTION

One objective of the present invention is to provide an object-oriented network-on-chip modeling, which does not restrict the adoption of the topologies, whereby a wider design exploration space is achieved. The word “modeling” of this present invention represents the NoC design process which uses all “models” given by this invention. Through these models and the process, the invention can lead users to construct a new NoC fast and accurately.

Another objective of the present invention is to provide an object-oriented network-on-chip modeling, which divides the system into components according to the hardware graphs and then designs each component into multi-abstraction level models.

The object-oriented network-on-chip modeling of the present invention uses the concept of “abstraction level” to balance the modeling accuracy and the construction overhead of a new NoC design. The so-called abstraction level is a package that the details of the hardware are contained in the component with higher level. If an abstraction level is examined microscopically, it is found that the characteristics of the hardware are well preserved thereinside. The present invention provides different abstraction levels of object implementation libraries. The components are directly used, or are inherited and modified before using them from the object implementation libraries. The coding time of a new NoC design is thus reduced. Therefore, the present invention can greatly reduce the detailed constructions of the hardware and effectively reduce the time used in simulation.

### BRIEF DESCRIPTION OF THE DRAWINGS

Below, the embodiments are described in detail in cooperation with the following drawings to make easily understood the objectives, characteristics and efficacies of the present invention:

FIG. 1 is a diagram schematically showing the design blocks of the Data-link Layer Channel (abbreviated as DC) according to the object-oriented NoC modeling of the present invention;

FIG. 2 is a diagram schematically showing the design templates to which an object implementation library is mapping of the design blocks in FIG. 1 and showing how to derive a NoC from the templates according to an object-oriented NoC modeling of the present invention;

FIG. 3 is a diagram schematically showing the concept of “port” and “virtual port ID” through a mesh-like network switch;

FIG. 4 is a diagram schematically showing the abstraction levels of the DC modeling of an object-oriented NoC modeling according to the present invention;

FIG. 5 is a diagram schematically showing an exemplification of a multi-abstraction-level DC design according to the DC modeling of an object-oriented NoC modeling according to the present invention;

FIG. 6 is a diagram schematically showing a DC hardware architecture in the data flow viewpoint according to an object-oriented NoC modeling of the present invention; and

FIG. 7 is a diagram schematically showing a double-ring network system according to an object-oriented NoC modeling of the present invention.

### DETAILED DESCRIPTION OF THE PREFERRED EMBODIMENTS

Below, the embodiments are described in detail in cooperation with the drawings to make easily understood the technical contents, characteristics and accomplishments of the present invention.

The present invention divides the NoC into three portions: a data-link-layer channel (abbreviated as DC), a DC linker and a NoC information center. The three portions are described in detail thereinafter.

### Data-Link-Layer Channel

The data-link-layer channel (DC) is a model including all NoC design issues in the network data-link-layer, such as port sharing, switching mechanisms, flow control, and buffer congestion control, etc. The data-link-layer channel and its abbreviation DC are alternately used thereinafter. The design issues of DC are grouped into seven design blocks to support all types of DC modelings in the present invention. When any one of the seven design blocks adopts a different design, the combination of the seven design blocks forms a new DC design.

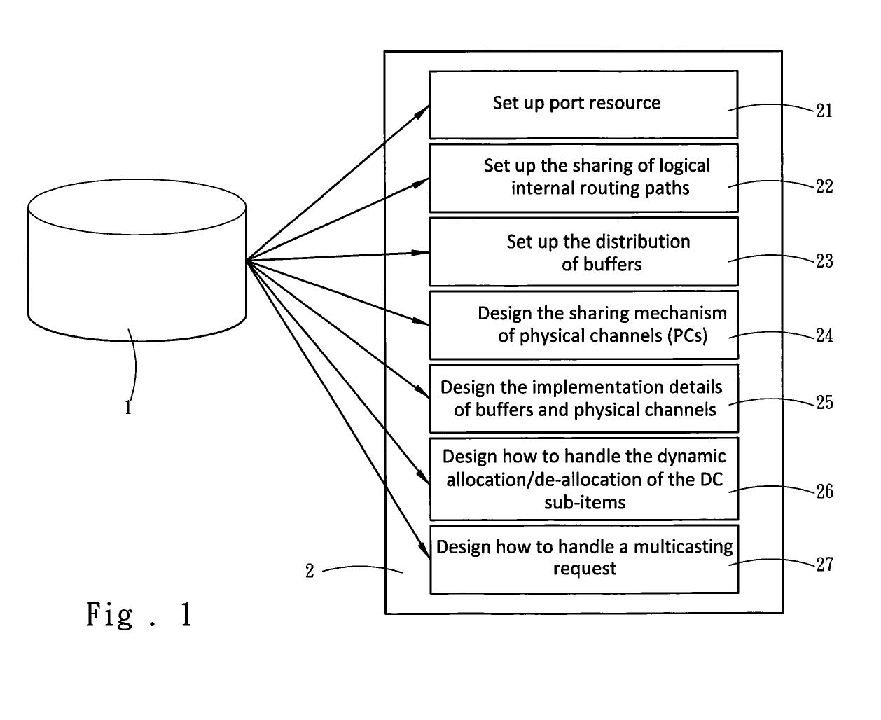

Refer to FIG. 1, wherein a DC 2 containing seven design blocks. The seven design blocks include a design block 21 for setting up port resource, a design block 22 for setting up the logical internal routing paths, a design block 23 for setting up the distribution of buffers, a design block 24 for designing the sharing mechanism of physical channels, a design block 25 for designing the implementation details of buffers and physical channels, a design block 26 for designing how to handle the dynamic allocation/de-allocation of the DC sub-items, and a design block 27 for designing how to handle a multicasting request. These seven design blocks will be described in detail below. The design templates of the DC 2 can be taken from an object implementation library 1 shown in FIG. 1 to avoid repeated coding. The object implementation library 1 can provide multiple design templates for each design block. The users can arbitrarily combine the templates to form their designs. Thereby, the simulator can support a very large design space easily.

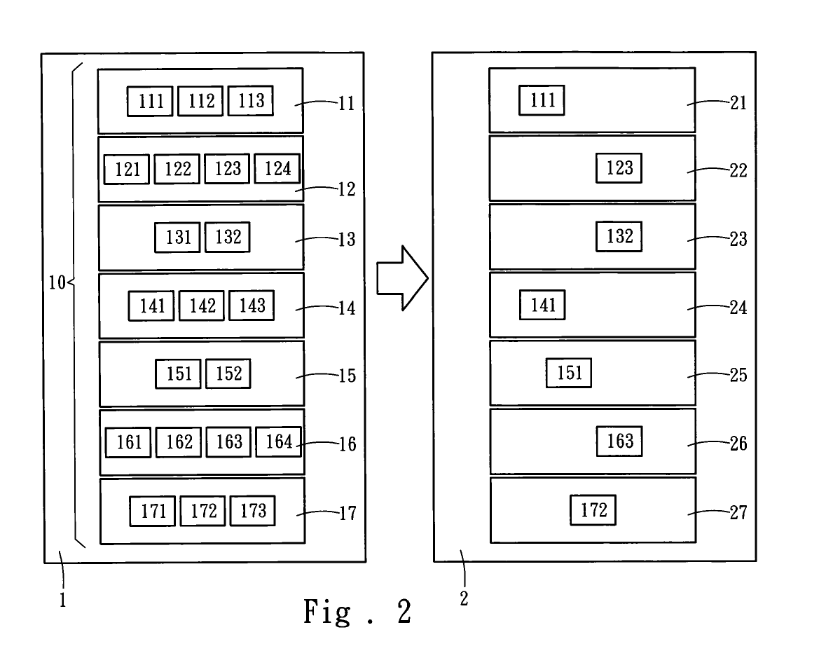

Refer to FIG. 2, wherein the object implementation library 1 is depicted in more details. The object implementation library 1 contains seven design blocks 11, 12, 13, 14, 15, 16 and 17 corresponding to the DC 2. Each design block of the object implementation library 1 includes a plurality of design templates 10. As an example, the design block 11 of the object implementation library 1 has three design templates 111, 112 and 113. The design block 12 has four design templates 121, 122, 123 and 124. The design block 13 has two design templates 131 and 132. The design block 14 has three design templates 141, 142 and 143. The design block 15 has two design templates 151 and 152. The design block 16 has four design templates 161, 162, 163 and 164. The design block 17 has three design templates 171, 172 and 173. Herein, the number of the design templates of each design block is only for exemplification. In the present invention, the number of the design templates of each design block is not limited to the number shown in FIG. 2. The design templates of different design blocks may have interdependence. For example, the design template 111 of the design block 11 might be able to combine with only the design template 123 of the design block 12 and the design template 132 of the design block 13.

The object implementation library 1 of the present invention includes a plurality of design templates 10. The user may select the required design templates 10 and directly fill them into an empty DC to complete the seven design blocks 21, 22, 23, 24, 25, 26 and 27. As shown in FIG. 2, the design templates 111, 123, 132, 141, 151, 163, and 172 are selected from the object implementation library 1 to implement the design of the DC 2. Once adopting the design templates, the DC can inherit the function blocks (not shown in the drawing) inside the templates to use the functions directly or just make a modification version from them. If the desired template does not exist, the user can create a new template of the design block according to the requirement codes. In a function block, the logical or hardware design is packaged into a replaceable component. Such an object-oriented design method can greatly reduce the coding time of the DC design. Further, the object-oriented design method can be used to explore different combinations of design templates. Therefore, the present invention can also greatly expand the design exploration space.

From the viewpoint of designing a DC, the seven design blocks of a DC module are filled to implement a new DC model, and then the model is constructed to a parameterized instance. From the viewpoint of object-oriented methodology, it is to inherit the objects of the DC module and complete a blank virtual function. Next, the variables of the object are declared in the top module of the program, and the parameters thereof are set. Then, the implementation of the DC model combines with the implementations of other objects to form a complete system.

In the specification, the design issues of a DC are divided into seven design blocks. However, the present invention does not limit the number of the design blocks.

The descriptions of the seven design blocks are as follows.

1. Design block 21 for setting up port resource:

The design block 21 describes the following design issues, including:

A. the number of the ports to/from each direction of the DC model, and
B. the number of the virtual port identities (VPIDs in short) of each port,
wherein the abovementioned virtual port is a logical port and shares an identical physical port with other logical ports, and the virtual port identity (VPID) is used to designate the virtual port.
2. Design block 22 for setting up the sharing of logical internal routing paths:

The design block 22 describes how the logical internal routing paths share all hardware transmission resources of the DC, wherein the logical internal routing path is a logical transmission channel that each pair of input VPID and output VPID must have, and wherein each logical internal routing path is determined by four fields: “input port name”, “input VPID”, “output port name” and “output VPID”, and each of the four fields must be a fixed value. The “port name” is used to designate different ports. The virtual port identity and its abbreviation VPID are alternately used thereinafter.

These logical internal routing paths are logically separate, but some of them physically use the same input buffers, switching time slots, or output buffers, because these hardware resources are insufficient. Thus, the logical internal routing paths are further grouped into many Ways, and the logical internal routing paths of the same Way share the same hardware transmission resources.

In the present invention, the Ways are defined via grouping the logical internal routing paths, and each Way is designated with the four fields of “input port name”, “input VPID”, “output port name” and “output VPID”. Each field is allowed to be a “fixed value” or a “don't care value”.

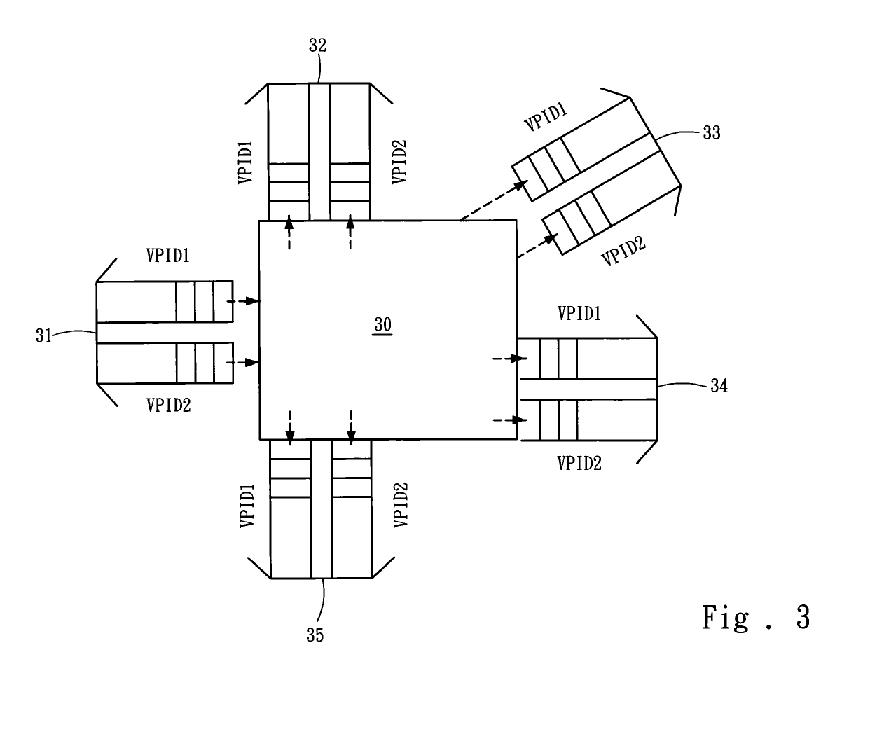

A Way design is to set up all the possible Ways that a DC can provide. Table.1 shows a Way design example, and FIG. 3 shows the corresponding hardware of this example.

TABLE 1
the design of a Way corresponding to the hardware shown in FIG. 3
Each Way is defined by four fields: “input port name”, “input VPID”,
“output port name” and “output VPID”, and X denotes “don't care”.

Way 1=(Port 1, VPID 1, Port 2, X)
Way 2=( Port 1, VPID 1, Port 3, X)
Way 3=( Port 1, VPID 1, Port 4, X)
Way 4=( Port 1, VPID 1, Port 5, X)
Way 5=( Port 1, VPID 2, Port 2, X)
Way 6=( Port 1, VPID 2, Port 3, X)
Way 7=( Port 1, VPID 2, Port 4, X)
Way 8=( Port 1, VPID 2, Port 5, X)

FIG. 3 shows a part of a mesh switch 30. Only five physical ports of the mesh switch 30 are shown in FIG. 3, including a first port 31, a second port 32, a third port 33, a fourth port 34 and a fifth port 35. The first port 31 is a physical input port, and the other ports 32, 33, 34 and 35 are all physical output ports. The logical ports corresponding to each physical port are also shown in FIG. 3. For example, the first port 32 is corresponding to two logical ports VPID1 and VPID 2.

In the design block 22 of setting up logical internal routing paths, the five ports of the block 30 in FIG. 3 may adopt an 8-Way design shown in Table.1, for example. These eight ways group the VPIDs of entering the first port 31 by different output port names according to their output ports regardless of their output VPIDs. For example, packages from VPID1 of the input port 31 to VPID 1 of the output port 33 might be blocked by packages from VPID1 of the input port 31 to VPID 2 of the output port 33 no matter whether there is sufficient transmission resource or not. However, if the packages respectively belong to different input VPIDs of the first port 31, the head-on-a-line blocking won't happen.

FIG. 3 and Table.1 are only to exemplify the design block 22 but not to limit the design block 22.

In the DC modeling, Ways may be regarded as an assemblage of the resources for undertaking transmission or as the logical resources that all services (including streams, packets, and flow-control units, etc.,) have to acquire when they pass through the DC. The DC collects all the hardware transmission resources and assigns the hardware transmission resources to Ways. A service cannot acquire the hardware transmission resources until it has acquired their owner Way.

In the specification, “service” is a term used in the latency model, and it may be a control request or a piece of data to be transmitted. Its definition is the same as the term “transaction” in Transaction-Level-Modeling methodology.

3. Design block 23 for setting up the distribution of buffers:

The design block 23 describes “how buffers are distributed to all the Ways” and “how buffers are distributed to all the output VPIDs”.

4. Design block 24 for designing the sharing mechanism of physical channels (PCs):

The design block 24 describes “the static distribution of PCs” and “how one PC is shared by many Ways”—the kernel design of DC.

There are many ways to assign static distribution of PCs of one DC. For example, there might be N Ways and M PC resources (N>=M). One design of static distribution is that every N/M ways share the same PC. Another design is that a special Way uses one PC and the other (N−1) Ways share the other (M−1) PCs.

The methods to deal with “how one PC is shared by many Ways” include the methods of round robin time-division-multiplexing (TDM), prioritizing handling according to Way ID, prioritizing handling according to the contents of waiting transfer packages, or first-come-first-serve, etc. In the specification, the transfer package is a traffic pattern, which may be a packet, a flow-control-unit or a transaction unit.

The abovementioned methods are the design templates that the design block 24 can support, but the present invention does not limit the design block 24 to the abovementioned methods.

5. Design block 25 for designing the implementation details of buffers and physical channels:

The design block 25 describes how to implement all buffers and all PCs that are used in the former design blocks 21, 22, 23 and 24, wherein different buffers or PCs can be used in different sections of NoC. For example, the congested sections of NoC adopt buffers that are high-efficiency but power-consuming; the remaining sections adopt buffers that are lower-efficiency but power-saving.

The present invention is characterized in that the algorithm designs of network routing and flow control are completely independent of the implementation of buffers and physical channels.

Thus, the present invention can modify, replace or mix buffers and PCs of different implementations very conveniently.

6. Design block 26 for designing how to handle the dynamic allocation/de-allocation of the DC sub-items:

The “DC sub-items” include the input buffers, Ways, PCs, and output VPIDs. They can be dynamically allocated to or de-allocated from one stream, one packet, or one flow control unit. The allocation and de-allocation often occur when a special stream, packet, or flow control unit passes through and makes a request. The design block 26 involves many strategies related to “flow control mechanisms”, such as the worm-hole flow control mechanism, the virtual channel (VC) flow control, etc. The present invention separates this design block from the implementation of buffers, PCs, switching mechanism, and any static configuration of DC, so users can easily implement different algorithmatic designs.

7. Design block 27 for designing how to handle a multicasting request:

DC does not limit a transfer package into only one logical internal routing path. In other words, multicast is allowed. This design block 27 describes how to multicast a transfer package. When multi-casted, a transfer package is sent to multiple logical internal routing paths. For example, it might be sent to only one selected Way, sent to all Ways at the same time, or sent to all Ways one by one. However, the present invention does not limit the transmission of transfer packages to the modes mentioned above.

The DC modeling formed of the design blocks 21 to 27 describes not only the logical designs but also the physical implementations. Therefore, the DC modeling of the present invention can enlarge the variability of simulation.

The NoC modeling of the present invention adopts a multi-abstraction-level design process. A single object of the present invention may involve the contents from abstract designs to physical designs, and the present invention resolves a single DC object into multiple abstraction levels. The implementations for the abovementioned design blocks in FIG. 1 are just distributed to several different abstraction levels of the modeling process.

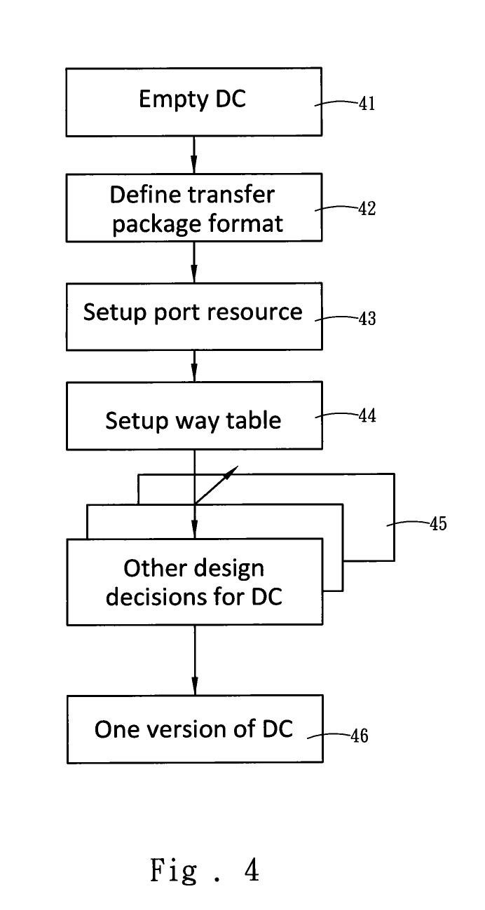

When intending to establish a new DC design, the user can fulfill the designs of each abstraction level one after another until a new version of DC is completed. Refer to FIG. 4, wherein the NoC modeling of the present invention is exemplified by only six abstraction levels. However, the present invention is not limited to the exemplification of FIG. 4. In FIG. 4, the DC design process begins from an empty DC 41 and then one after another undertakes the steps of defining transfer package formats 42, setting up port resources 43, designing the Way resources 44, and in the end a new design of DC 46 is established. In fact, the NoC design usually requires other design decisions. Thus, the step of deciding other designs 45 is added to FIG. 4. As mentioned above, the present invention provides each design block with selectable templates. While making a decision within different abstraction levels, the designer does not need to write new program codes but merely to select appropriate templates for the abstraction levels one after another until a new design of DC is completed. Such a simulation modeling of the present invention not only supports the widest range of NoC designs but also enables the simulation of mixed abstraction levels. Further, the present invention can solve the problem that the conventional mixed-level simulator has to pay much coding effort to construct a new NoC.

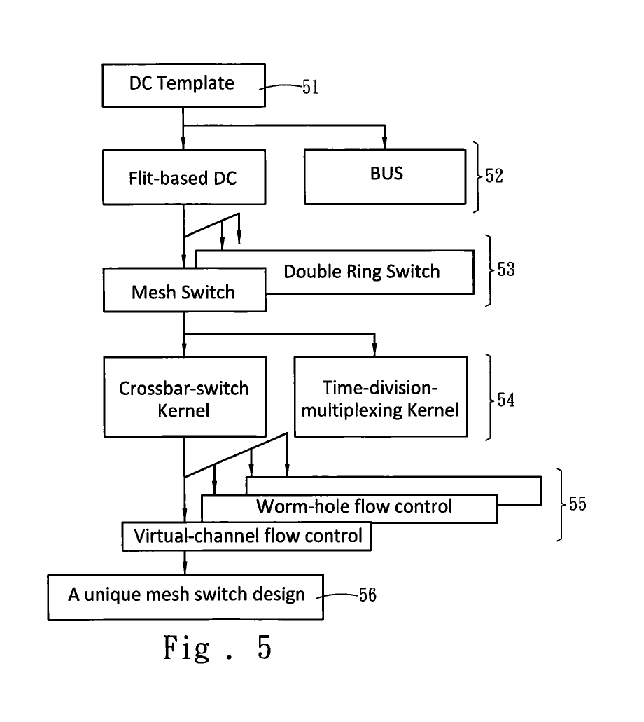

FIG. 5 is a block diagram schematically showing an exemplification of a multi-abstraction-level modeling of the DC according to the present invention. However, the present invention is not limited to the exemplification. The bottommost block 56 is a flow-control-unit switch of a mesh-like network. The blocks 51-56 respectively describe different abstraction levels of the Flit (Flow-control-unit) switch of the mesh-like network. Each level in FIG. 5 exemplifies each level of in FIG. 4. The selectable design templates for each level are also shown in FIG. 5. Firstly, selecting an empty DC design template 51 is undertaken. Next, defining a transfer package format 52 is undertaken in the first level. Only two transfer package formats in the first level are shown in FIG. 5, including a Flit-based DC and a transaction-unit-based bus. Next, setting up port resources 53 is undertaken, and two exemplifications thereof are shown in FIG. 5, including a mesh switch and a double-ring switch. Next, setting up the Way table 54 is undertaken in the third level, and two exemplifications thereof are shown in FIG. 5, including a crossbar-switch kernel DC and a TDM (time division multiplexer) kernel DC. Next, adding other DC designs 55 is undertaken in the fifth level, including virtual channel flow control or worm-hole flow control. Then, a desired design 56 is obtained.

The present invention uses the multi-abstraction-level designs to construct a new design module, whereby coding-reuse is increased, and coding time of a new DC design is reduced. The tree-like structure shown in FIG. 5 can contain almost each of the possible design essence of a DC design and enable an automatic exploration of NoC design.

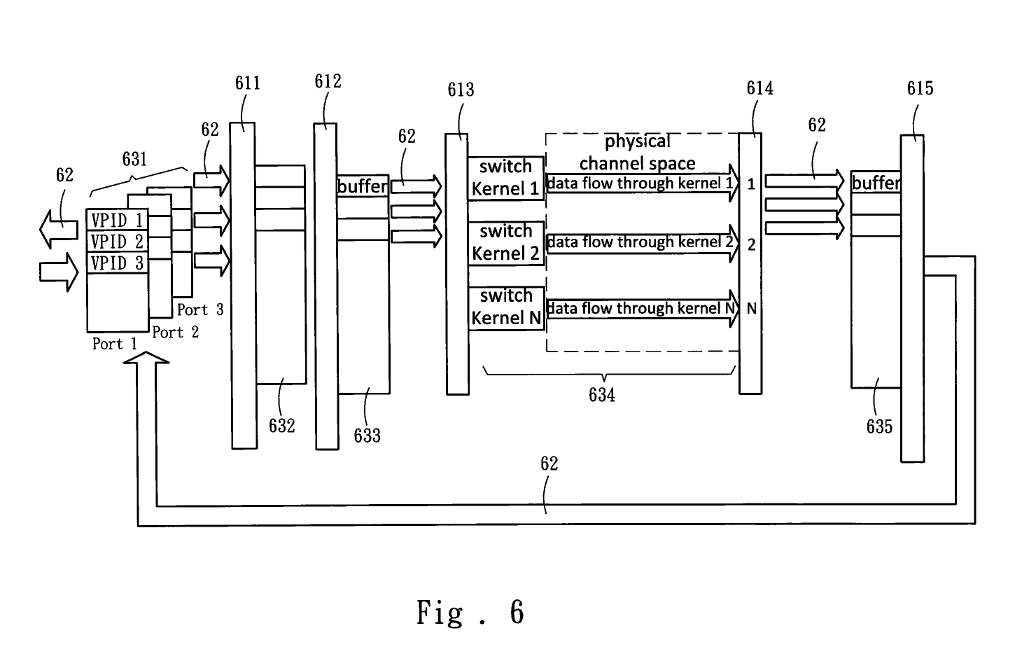

When a DC object of higher-abstraction-level is examined microscopically, the characteristics of the hardware architecture are still preserved thereinside. The object can be viewed as the combination of multiple “hardware structures” whose behaviors are determined by all design blocks mentioned in FIG. 1 through the modeling process as FIG. 4. Refer to FIG. 6 for these “hardware structures”. The object-oriented DC architecture in FIG. 6 includes five handling stages and each stage is corresponding to a resource contention point. The arrows in FIG. 6 denote the data flows of transfer packages. After written into the DC, the transfer package is transmitted to at least one Way resources 632, and a first class resource contention point 611 is thus created. The Way resource 632 represents the relationship between the virtual routing paths and the physical transmission resource. The transfer package cannot indirectly acquire the physical transmission resource unless it obtains the Way resource 632 beforehand. The physical transmission resource is exemplified by the buffer resource in FIG. 6. However, the present invention does not limit the physical transmission resource to the buffer resource. After acquiring the Way, the transfer package needs to acquire the buffer resource 633, and a second class resource contention point 612 is thus created. After acquiring the buffer resource, the transfer package proceeds to compete for the switch and physical channel resource 634, and a third class resource contention point 613 is thus created. Via the service of switches, the transfer package enters the physical channel. Then, in order to acquire an output buffer resource 635, a fourth class resource contention point 614 is thus created. Finally, while reading out from the DC, the output port resource 631 has to be acquired, and a fifth class resource contention point 615 is thus created.

The complete go-though latency of a transfer package is the summation of “go-through latency between every two resource contention points” and “the handling latency and waiting time at each resource contention point”. All the above-mentioned latencies and designs are described in the DC design blocks, for example, the design blocks 21-27.

FIG. 6 demonstrates how to evaluate the latency from the architecture level of the DC model of the present invention. Nevertheless, FIG. 6 is only an exemplification of the present invention, and the present invention is not limited to the contentions, formats and transmission sequence of the transfer packages in FIG. 6.

The present invention adopts a “cycle-approximation latency model” to evaluate the performance. The cycle-approximate latency model considers the behavior of each service handler as a plurality of sub-behaviors thereof. Each sub-behavior may be divided into one or more sequential sub-actions each of which has parameterized latency. The sub-behaviors of one Service handler may proceed in parallel or sequentially. Some sub-behavior will not occur until a special event or a combination of special events has occurred. The latency of a Service handler also comprises the queue time waiting for other Services to be served. Thus, the latency has a tree-like structure, and the final latency of each node of this tree is the summation of the latency estimation of all its child nodes. Furthermore, the latency estimation of each node of the same tree-level might be dependent.

The cycle-approximation latency model is explained more in detail below. The total execution time of one application might be the time the commit of all parallel tasks occurs. The execution time of an application “task” is the summation of the time used in computation activities and communication activities, and it might be expressed by “total execution time”={computation activity, communication activity, computation activity}. The abovementioned communication activity may be resolved into many sub-activities, and it may be expressed by “communication time”={adaptor go-through time, switch go-through time, . . . , (more)}. The abovementioned switch go-through time may be resolved into further smaller components and expressed by “switch go-through time”={routing go-through time, resource allocation go-through time, . . . , (more)}. In the cycle-approximation latency model, the latencies are developed level by level to form a tree-like structure. The behavior latency time of the top-level is the summation of the latencies of the tree-like structure. The abovementioned latency items are only for exemplification of how the present invention estimates latency, but the present invention doesn't restrict its latency models.

As mentioned above, the present invention divides NoC into three components: a DC, a DC linker and a NoC information center. Below is described the DC linker.

### DC Linker

The DC linker is a model involving all the logical and physical designs between two DCs. The DC linker includes a routing algorithm, a VC (Virtual Channel) allocation strategy and a linkage transfer mechanism. The DC linker model connects two DCs in a port-to-port, port-to-VPID, VPID-to-port, or VPID-to-VPID way. In the DC linker model of the present invention, data is transmitted from one DC to another DC through a linkage path. The linking mechanism is configurable, including half-duplex, full duplex, or bidirectional connection. The linkage transfer mechanism, the routing algorithm and the VC allocation strategy can be configured independently. When the DC linker is under simulation, at least one logical internal routing path is determined according to the routing algorithm and the VC allocation algorithm, and a transfer package enters another DC via the determined logical internal routing path.

Below is the comparison of the DC and the DC linker. The DC determines how to handle the transfer package from at least one given input VPIDs of at least one given input ports to at least one given output VPIDs of at least one given output ports. The DC linker, however, determines “which” input VPID of “which” input port and “which” output VPID of “which” output port for the transfer package to go. DC linkers can get all required information for routing and allocation from the NoC information center, which is described later.

The DC linker is responsible for data transfer and determining the ports and VPIDs for passing transfer packages. The DC linker also contains a DC access module for at least one DC which may be regarded as a status center. The status center can obtain the usage status of the physical transmission resources of the near-end DCs. The DC linker allocates the physical transmission resources before the transfer package enters the DC. The status center obtains the usage status of the physical transmission resources used by the far-end DCs from the NoC information center. The DC linker of the present invention is responsible for the abovementioned tasks at least. However, the present invention does not limit the hardware to complete the tasks of a DC linker or the sequence to complete the tasks of a DC linker.

### NoC Information Center

The NoC Information Center is defined as a static or dynamic NoC information provider. The information includes the congestion status of the entire NoC, the global routing table and the local routing information. Via the NoC information center, the design spaces of how the DC and DC linker use the above-mentioned information of NoC are independent from how DC/DC linker generates and transfers the information. Therefore, the present invention is able to simulate different routing/adaption/quality-of-service designs without hardware coding modification. In the present invention, the NoC information center is not an essential component. The NoC modeling of the present invention does not necessarily include a NoC information center.

### How to Combine all NoC Components

A NoC design is formed through combining the components of the object-oriented NoC models, including the DC, DC linker and NoC information center, buffers and physical channels.

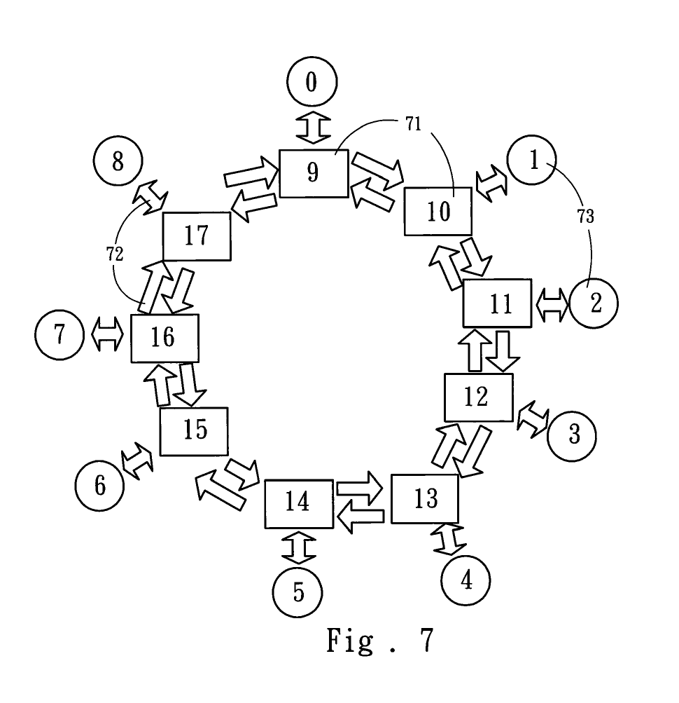

Refer to FIG. 7 for a double-ring network system designed according to the object-oriented NoC modeling of the present invention. The NoC information center is not shown in FIG. 7, and the buffers and physical channels are contained in the DC and DC linker. In FIG. 7, each block 71 denotes a DC. According to the object-oriented NoC modeling of the present invention, each DC 71 may be resolved into seven design blocks in FIG. 1. The design block inherits and modifies the design templates in the object implementation library to design the details of the DC. In FIG. 7, each circle denotes an adaptor 73, which is connected to processing elements (not shown in FIG. 7). The adaptor 73 may be regarded as a special DC unit. In the adaptor 73, a transfer package has fixed transmission directions, and the logical internal routing paths have only two options—into the processing element and out of the processing element. In FIG. 7, each arrow denotes a DC linker 72, and one DC linker 72 transmits along the direction of the arrow the transfer package of the DC 71. The bidirectional arrow stands for the two arrow notations with opposite directions, each of which denotes a DC linker 72.

The double-ring NoC system shown in FIG. 7 is only an exemplification of the NoC designs supported by the object-oriented NoC modeling of the present invention. However, the present invention is not limited to support the double-ring NoC system but also support other NoC systems, such as a mesh-like network system or a multi-stage network.

In a conventional simulator, the detailed tasks of hardware construction and wiring must be completed before the performance simulation. The simulator of the present invention includes a registry table describing all DC linkers. In the registry table, each DC linker has a DC linker identity (DC linker ID), which describes the relationship between physical ports and virtual ports. The registry table also shows the transmission methods which a transfer package is transmitted between DCs. The system performs simulation according to the registry table. The higher-level unit contains the hardware details used in the conventional simulation. For example, a DC linker is regarded as the relationship of the physical ports between two DCs. From a microscopic view, the DC linker contains the wiring details of the conventional simulation. Thus, the abovementioned cycle-approximation latency model expands all the latencies occurring in the transmission of a transfer package and accumulates all the latencies to complete the performance evaluation of the system. Therefore, the object-oriented NoC modeling of the present invention can evaluate NoC performance from higher levels preserving the hardware characteristics and constructing no details of hardware designs such as wiring.

### Demonstration of Coding Effort Reduction

As mentioned above, the object-oriented NoC modeling of the present invention can greatly reduce coding effort. Table.2 shows the coding for a new NoC design.

TABLE 2
coding effort for a new NoC design

| | Code Type | | |
|---|---|---|---|
| | Number of | Number of | Number of |
| | Coding Shared | Coding | Hard-coding |
| | Lines of DC | Different Lines | Lines of DC |
| NoC Type | Objects | of DC Objects | Objects |
| mesh network | 7797 | 325 | 105 |
| double ring | 7797 | 333 | 81 |
| network | | | |
| binary tree | 7797 | 352 | 129 |
| network | | | |
| multi-stage | 7797 | 294 | 46 |
| network | | | |

In Table.2, the “coding shared lines” means the coding lines for functions or objects that can be shared by different NoCs. The “coding different lines” means the coding lines for functions or objects uniquely belonging to one NoC design. The “hard-coding lines” means the lines which are really different in those “coding different lines”. For example, suppose that the mesh network is different from the binary tree network only in VC allocation, and that the VC allocation of the mesh network is called Function A, and that the VC allocation of the binary tree network is called Function B. Thus, the “coding different lines” of the mesh network are the lines of Function A, and the “coding different lines” of the binary tree network are the lines of Function B. However, there are parts in Functions A and B just written in the same codes. The rest of lines in Function A are the “hard-coding lines” of the mesh network. The rest of lines in Function B are the “hard-coding lines” of the binary tree network.

In the present invention, the design space of a NoC system is divided into several layers, and each layer is divided into several components, and each component is modeled into several abstraction levels. Further, the present invention parameterizes all latency items of each cycle-approximation latency model adopted by the abovementioned NoC components to evaluate the system performance.

The embodiments described above are only to demonstrate the spirit and characteristics of the present invention but not to limit the scope of the present invention. The scope of the present invention is based on the claims stated below. However, it should be interpreted from the broadest view, and any equivalent modification or variation according to spirit of the present invention should be also included within the scope of the present invention.

What is claimed is:

1. An object-oriented network-on-chip modeling, which divides a design space of a network-on-chip into multiple components and models each said component into multiple abstraction levels, comprising:
a DC (data-link-layer channel) modeling, wherein said network-on-chip (NoC) contains multiple DCs, and said DC modeling includes a plurality of design issues of each said DC, and said design issues are grouped into a plurality of design blocks; and
a DC linker modeling defining a transmission mechanism, a linkage mechanism and a decision mechanism of a transfer package for every two said DCs, whereby said transfer package can be transmitted from one said DC to another said DC via a linkage path,
wherein said abstraction level packs details of a hardware transaction in a higher-level structure to form a package whereby greatly reducing time spent on construction and simulation of said NoC, and
wherein a performance evaluation method is used to evaluate performance of said NoC.

2. The object-oriented network-on-chip modeling according to claim 1 further comprising a NoC information center, which makes the designs using the status or global information of NoC independent from the designs getting the information of said DC or said DC linker.

3. The object-oriented network-on-chip modeling according to claim 1, wherein said design blocks of said DC modeling include:
a design block for setting up port resources, wherein each said DC has at least one port accompanied with at least one virtual port, and wherein said design block for setting up port resources describes a number of said ports contained in each said DC, and a number of said virtual ports contained in each said port;
a design block for setting up sharing mechanism of logical internal routing paths, wherein said logical internal routing path is a logical transmission channel between an input virtual port and an output virtual port in each said DC, and wherein said logical transmission channels are grouped into a plurality of Ways;
a design block for setting up distribution of buffers, wherein each said DC has a hardware resource comprising a plurality of buffers, and wherein said design block for setting up distribution of buffers describes the distribution of said buffers to all said Ways and the distribution of buffers to all said output virtual ports;
a design block for designing sharing mechanisms of physical channels, wherein each said DC has a hardware resource comprising a plurality of physical channels, and wherein said design block for designing sharing mechanisms of physical channels describes the sharing of said physical channels by said Ways;
a design block for designing implementation details of said buffers and said physical channels, which describes how to implement all said buffers and all said physical channels;
a design block for designing how to handle dynamic allocation/de-allocation, which describes how to handle dynamic allocation/de-allocation of said buffers, said Ways, said physical channels and said output virtual ports; and
a design block for designing how to multicast, which describes how to handle a multicasting request, wherein said design blocks select a plurality of design templates from an implementation library and fill said design templates into an empty said DC modeling to inherit function blocks of said design templates to realize an object-oriented NoC modeling, whereby coding time is greatly reduced in said object-oriented NoC design.

4. The object-oriented network-on-chip modeling according to claim 3, wherein said Way is described with multiple fields, include:
an input port name,
an input virtual port identity,
an output port name, and
an output virtual port identity,
wherein each said field is a fixed value or a don't-care value.

5. The object-oriented network-on-chip modeling according to claim 1, wherein said performance evaluation method is a cycle-approximation latency modeling.
